(19) United States
(12) Patent Application Publication
(10) Pub. No.: US 2001/0027402 A1
(43) Pub. Date: Oct. 4, 2001

(54) Method and apparatus for effectuating bilateral, consumer-driven healthcare commerce

(76) Inventor: Peter R. Ramsaroop, Alexandria, VA (US)

Correspondence Address: ROYLANCE, ABRAMS, BERRO & GOODMAN, L.L.P., 1300 19TH STREET, N.W., SUITE 600, WASHINGTON,, DC, 20036, US

(21) Appl. No.: 09/782,602

(22) Filed: Feb. 14, 2001

Related U.S. Application Data
(60) Provisional application No. 60/182,210, filed on Feb. 14, 2000.
(60) Provisional application No. 60/189,470, filed on Mar. 15, 2000.

(51) Int. Cl. G06F 17/60

(52) U.S. Cl. 705/2

(57) ABSTRACT

A method and apparatus for effectuating consumer-driven healthcare commerce. The method and apparatus allows consumers of healthcare to conduct and control the movement of their healthcare records virtually and globally. It also allows the electronic transfer of the personal health records from one institutional data system to another by mapping individual protocols of one system to another. The consumer is permitted to manage their individual healthcare information storage and movement. The method and apparatus includes the storage of personal health information, which can be constantly updated, permanent health information from various healthcare institutional sources, and healthcare genealogical information. Also, the individual consumer can selectively transfer or access the information electronically, as needed.

### RELATED APPLICATIONS

This application claims the benefit of U.S. Provisional Application Nos. 60/182,210 and 60/189,470 filed on Feb. 14, 2000 and Mar. 15, 2000, respectively, the subject matter of both being incorporated herein by reference.

### FIELD OF THE INVENTION

The invention generally relates to a method and apparatus for permitting individual consumers to accumulate their personal healthcare information for future reference and for selective dissemination. More specifically, the invention relates to a method and apparatus for receiving healthcare information via the Internet from individuals and their healthcare institutions and providing a storage facility that can be accessed via the Internet for subsequent personal use or for subsequent use by other healthcare institutions at the individual's discretion.

### BACKGROUND OF THE INVENTION

Known electronic healthcare storage databases are operated by individual healthcare institutions so that they can collect, store, and retrieve the accumulated data on a specific patient. However, this data is usually not complete since it does not contain all of the patient's healthcare information, especially if the patient receives healthcare from multiple healthcare institutions. Further, since known databases are operated and controlled by institutions, they are not easily accessed by the individual patient. In addition, the individual patient has no control over the information in the databases.

Thus, there is a continuing need to provide a single healthcare database that is complete, easily updateable, easily accessible, and controlled by the individual patient. This invention addresses these needs in the art as well as other needs, which will become apparent to those skilled in view of this disclosure.

### SUMMARY OF THE INVENTION

Accordingly, an object of the present invention is to provide a healthcare database for individual patients.

Another object of the present invention is to provide a healthcare database for individual patients that is controlled by individual patients.

Yet another object of the present invention is to provide a healthcare database for individual patients which compiles and maintains a complete personal medical history of an individual patient and provides easy access thereto.

Still another object of the present invention is to provide a database of healthcare information accessible by the Internet.

The foregoing objects are basically attained by a method of creating and maintaining a consumer-driven healthcare database, comprising the steps of providing a first set of medical data from a first healthcare provider to a data management system, with the first set of medical data containing medical information regarding a healthcare consumer. The method also includes the steps of providing a second set of medical data from the healthcare consumer to the data management system, with the second set of medical data containing medical information regarding the healthcare consumer, and the healthcare consumer has access to the first and second sets of medical data. In addition, the method includes categorizing each of the first and second sets of medical data, respectively, within the data management system into at least a first category, and retrieving selected portions of data by the healthcare consumer from either of the first and second sets of medical data, respectively. Also, the method includes supplying the selected portions of data to either one of the healthcare consumer and a second healthcare provider.

By creating and maintaining a data management system in this manner, the individual patient can control and disseminate their own medical information as well as access medical data provided by one or more healthcare institutions regarding the patient.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

Referring to the attached drawings, which form a part of this disclosure:

FIG. 1 is a functional block diagram illustrating an example of a data management system according to a preferred embodiment of the subject invention;

FIG. 2 is a more functional block diagram of the system shown in FIG. 1;

FIG. 3 is a flowchart illustrating exemplary steps for creating a new health database account in accordance with an embodiment of the present invention; and

FIG. 4 is a flowchart illustrating exemplary steps for updating a health database account in accordance with an embodiment of the present invention.

### DETAILED DESCRIPTION OF THE PREFERRED EMBODIMENTS

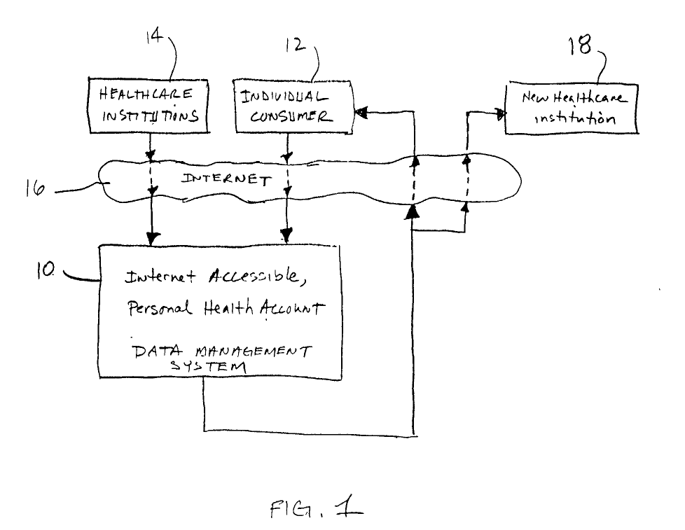

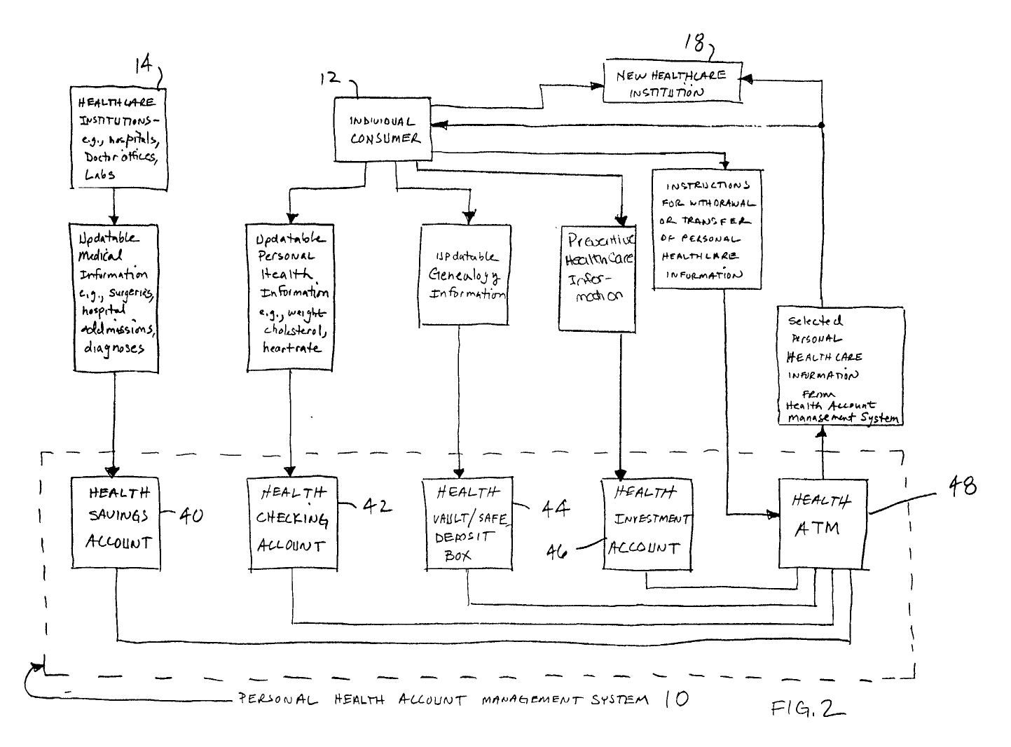

Referring to FIGS. 1 and 2, the present invention allows consumers of healthcare to conduct and control the movement of their healthcare records virtually and globally. It also permits the consumer to electronically transfer their personal health records from one institutional data system to another by mapping individual protocols of one system to another.

An example of a preferred embodiment of the present invention includes a data management system 10 that can receive information from an individual consumer or patient 12 of the healthcare system and from healthcare institutions 14, such as hospitals, doctor offices, laboratories, and so on as seen in FIG. 1. Also, the management system 10 can be easily accessed by the consumer 12 in order to perform a variety of functions, including obtaining the healthcare data stored by the management system 10 or forwarding the data to another healthcare institution 18 which requires the information.

The data management system 10 preferably includes a computer database capable of being remotely accessed. The remote access to the system 10 preferably occurs through the Internet 16, World Wide Web, or similar system, but can take any acceptable form, such as through telephone communications. Additionally, the connections with the data management system 10 can be through telecommunication lines or through wireless technology, such as through the use of satellite technology.

The data management system 10 includes multiple, interconnected and updateable computer databases, including a health savings account 40, a health checking account 42, a health vault/safe deposit box 44, and a health investment account 46, as seen in FIG. 2. The data management system 10 also includes a data-managing device in the form of a Health ATM 48. The ATM 48 acts as an automated teller machine to enable the consumer 12 to manage the data stored within the system 10. For example, the consumer 12 can access the information within the data management system 10 and perform functions such as move, transfer or withdraw the information.

The invention allows the consumers 12 to manage their healthcare information and movement by providing multiple categories of control by the consumers 12. In one category, the consumer 12 makes a deposit of personal health information into the checking account 42, which can be constantly updated by the consumer 12 and stored by the management system 10. The personal health information can include any relevant health information, such as, cholesterol levels, weight, blood type, and so on.

In a second category, information that is critical to the genealogy of the consumer's family and the health history of the consumer's family, such as heart conditions, diabetes, and so on, can be inserted and stored in the electronic vault 44. Thus, the data management system 10 includes the accumulation of both the institutional data and the personal data to form a complete medical record of the consumer 12.

In a third category, health information from various sources such as healthcare institutions 14, such as hospitals, doctors' offices, laboratories, and various medical departments, such as a radiology or oncology department, will be permanently transferred to the health savings account 40 for consumer 12 control and long-term storage. The permanent health information can include any relevant health information, such as surgeries, hospitalizations, doctor visits and diagnoses.

A fourth category of control allows the consumer 12 to store and access medical information regarding preventative care with the investment account 46. For example, in healthcare information can be provided to the consumer 12, to educate the consumer 12 on healthcare matters. For example, “push technologies” can be employed to send health reminders, health information relevant to the individual or family member, the latest chronic disease management advice, or information on first aid. Also, health risk assessments and scheduling reminders for preventative care examinations can be included within account 46.

In a fifth category of control, the consumer 12 can selectively retrieve the medical data from either of the savings account 40, the checking account 42, the health vault 44, and the investment account 46 to transfer the data to other parties as needed. If consumer health information is needed by a new healthcare entity 18, such as a new doctor, the consumer 12 can select, via the ATM 48, to electronically or otherwise transfer specific data or the entire medical record to new healthcare entity 18 or institution. This allows only the consumer 12 to transfer their medical data.

Also, the consumer 12 can withdraw or retrieve healthcare information from any of the savings account 40, the checking account 42, the health vault 44, and the investment account 46 as needed. For instance, the consumer 12 can upload some or all of their personal healthcare information to a personal digital assistant, such as a Palm Pilot, or to a personal computer, and formulate a hard copy if desired.

As stated above, the consumer 12 can access the data management system 10 in any number of ways, including the consumer 12 connecting to the Internet and logging onto the web site of the management system 10. The information can be transmitted to the management system 10 in any number of ways, including using computers and transferring the data to the management system 10 via the Internet.

It should be understood that the invention preferably includes the ability for any data transmitted and received between any of the consumer 12, the institutions 14 and 18, and the management system 10, to be encrypted prior to being transmitted in an unsecured manner, such as via the Internet, and then deciphered once received by the intended entity.

The embodiment of the subject invention described above further enables individual consumers 12 to manage their personal health records in the same way as their personal bank account using “pull technology.” The management system 10 provides its e-health consumers 12 the capability of depositing their medical information (e.g., cholesterol levels, weight, blood type, etc.) into the health checking account 42. Permanent information such as surgeries and hospitalizations will be stored in their health savings account 40. Personal family history such as heart conditions and diabetes will be kept secured in a ‘virtual vault’ 44, creating a legacy health record that can be passed onto future generations as part of a family's genealogical archive.

Consumers 12 will be able to withdraw, via the ATM 48, key health information and transfer it to a new physician or healthcare provider via smart cards, paper, or other electronic mediums when needed, such as when embarking on a cruise or other travels, where it would otherwise not be accessible. Further, the ATM 48 can be used to view information globally via the Internet or by other computer-based systems, such as on a personal digital assistant, such as a Palm Pilot.

In summary, the invention permits a single, central, store and retrieval location for all of the consumer's health information. Accordingly, a consumer 12 does not have to search through different providers' offices, ask relatives, and so on. to find required medical information. Additionally, through the use of the ATM 48, with either card or cardless access, consumers 12 can access their health information immediately and in emergencies, while being assured that the information is secure and confidential during storage as well as any transmission of data. Finally, by accessing the management system 10, for instance, via the Internet, the consumer 12 can be directed and linked to other relevant healthcare web sites.

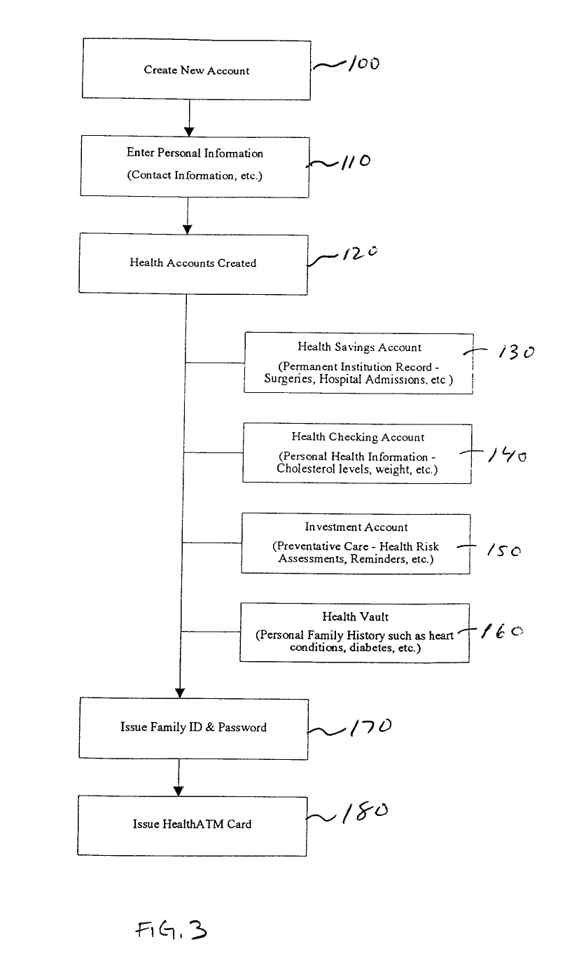

FIG. 3 illustrates a flowchart showing an example of a preferred manner for creating a new account for the consumer 12 in the management system 10. Specifically, once the account creation process is begun in step 100, personal information is loaded into a computer program adapted to receive the specific information in step 110. The health accounts are thus created in step 120, and information is distributed within the system 10 to the appropriate accounts 40, 42, 46 or the vault 44, in steps 130, 140, 150 and 160, until transfer, withdrawal or other manipulation at a later date. Then, the consumer 12 is issued an identification card and password in step 170 to maintain confidentiality, as well as an ATM card with identifying information in step 180 to allow access to the accounts in any variety of ways, when necessary.

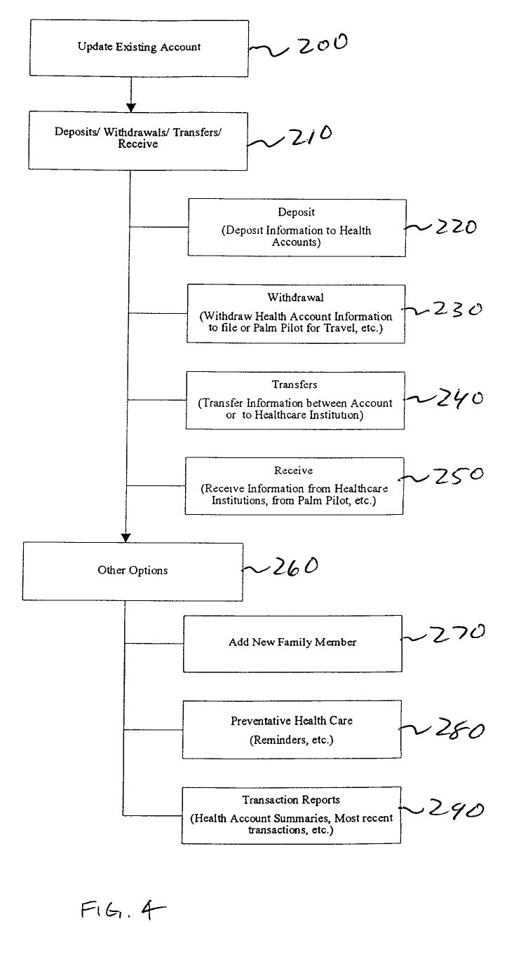

FIG. 4 illustrates a flowchart showing an example of a preferred manner for updating an existing account for the consumer 12 in the management system 10. Specifically, once the updating process is begun in step 200, the information in the account is updated in step 210 with new information by a deposit, or is withdrawn or transferred in the system 10. The information is then distributed within the system 10 to the appropriate accounts 40, 42, 46 or the vault 44, in steps 220 through 250, until transfer, withdrawal or other manipulation at a later date. Beginning at step 260, the consumer 12 also is presented with additional options to add additional family member (step 270), receive health reminders from the investment account 46 (step 280) or receive transactional reports such as health account summaries or recent transaction information (step 290). Also, health savings account 40 can receive updated medical information from healthcare institutions 14.

While advantageous embodiments have been chosen to illustrate the invention, it will be understood by those skilled in the art from this disclosure that various changes and modifications can be made therein without departing from the scope of the invention.

What is claimed is:

1. A method of creating and maintaining a consumer-driven healthcare database, comprising the steps of:
providing a first set of medical data from a first healthcare provider to a data management system, the first set of medical data containing medical information regarding a healthcare consumer;
providing a second set of medical data from the healthcare consumer to the data management system, the second set of medical data containing medical information regarding the healthcare consumer and the healthcare consumer having access to the first and second sets of medical data stored within the data management system;
categorizing each of the first and second sets of medical data, respectively, within the data management system into at least a first category;
retrieving selected portions of data by the healthcare consumer from either of the first and second sets of medical data, respectively; and
supplying the selected portions of data to either one of the healthcare consumer and a second healthcare provider.
